(19) United States
(12) Patent Application Publication
(10) Pub. No.: US 2015/0188916 A1
(43) Pub. Date: Jul. 2, 2015

(54) VPN CONNECTION AUTHENTICATION SYSTEM, USER TERMINAL, AUTHENTICATION SERVER, BIOMETRIC AUTHENTICATION RESULT EVIDENCE INFORMATION VERIFICATION SERVER, VPN CONNECTION SERVER, AND COMPUTER PROGRAM PRODUCT

(71) Applicants: KABUSHIKI KAISHA TOSHIBA, Minato-ku (JP); TOSHIBA SOLUTIONS CORPORATION, Kawasaki-shi (JP)

(72) Inventors: Asahiko YAMADA, Tokorozawa (JP); Tatsuro IKEDA, Fuchu (JP)

(73) Assignees: KABUSHIKI KAISHA TOSHIBA, Minato-ku (JP); TOSHIBA SOLUTIONS CORPORATION, Kawasaki-shi (JP)

(21) Appl. No.: 14/657,755

(22) Filed: Mar. 13, 2015

Related U.S. Application Data
(63) Continuation of application No. PCT/JP2013/074989, filed on Sep. 17, 2013.

(30) Foreign Application Priority Data
Sep. 14, 2012 (JP) 2012-202931

(51) Int. Cl. H04L 29/06

(52) U.S. Cl. CPC H04L 63/0861; H04L 63/0272

(57) ABSTRACT

According to one embodiment, there is provided a VPN connection authentication system including a user terminal that is used by a user, an authentication server that is connected to the user terminal and configured to communicate with the user terminal, a biometric authentication result evidence information verification server that is incorporated in the authentication server or is connected to the authentication server and configured to communicate with the authentication server, an authentication information management DB configured to be writable from the authentication server, and a VPN connection server that is connected to the user terminal by VPN and configured to communicate with the user terminal.

### CROSS-REFERENCE TO RELATED APPLICATIONS

This application is a Continuation Application of PCT Application No. PCT/JP2013/074989, filed Sep. 17, 2013 and based upon and claiming the benefit of priority from Japanese Patent Application No. 2012-202931, filed Sep. 14, 2012, the entire contents of all of which are incorporated herein by reference.

### FIELD

Embodiments described herein relate generally to a VPN connection authentication system, a user terminal, an authentication server, a biometric authentication result evidence information verification server, a VPN connection server, and a computer program product.

### BACKGROUND

VPN (Virtual Private Network) connection is used for connection to an office network in mobile computing. In VPN connection, user authentication is requested of a user as authentication of whether the user has the authority to connect. For the user authentication, only a first or second authentication function can be used. The first authentication function is an authentication function provided by a VPN product. The second authentication function is an authentication function that is provided by a product other than a VPN product and which can cooperate with a VPN product.

A VPN product provides password authentication and authentication using a PKI (Public Key Infrastructure). A product having an authentication function cooperative with the VPN product uses an authentication apparatus that generates a one-time password. This apparatus transmits a one-time password displayed on the authentication apparatus as the password of a VPN product from a VPN connection client to a VPN connection server. This apparatus causes a product, for which the VPN connection server has the authentication function, to verify the one-time password transmitted as a password.

There is also a biometric authentication product that performs biometric authentication to specify a user by using biometric information. This product stores a VPN user authentication password. When biometric authentication succeeds, the biometric authentication product extracts the VPN user authentication password, and transfers it to a VPN connection client to perform user authentication of a VPN connection.

In user authentication, both security and user friendliness need to be satisfied. However, password authentication suffers many security threats such as password theft and has a security problem. When authentication using PKI is used, network security is improved. However, in authentication using a PKI, a personal identification number or the like is used to allow the use of a stored private key. For this reason, security in a client is at the same level as password authentication.

Since a one-time password is used in authentication using an authentication apparatus that generates a one-time password, the security level is enhanced. However, a one-time password has a larger number of characters than a normal password. The user needs to enter a one-time password displayed on the authentication apparatus. This impairs user friendliness.

A biometric authentication product stores a VPN user authentication password. When biometric authentication succeeds, the biometric authentication product extracts the VPN user authentication password, and transfers it to a VPN connection client to perform user authentication of a VPN connection. In this case, user friendliness is improved. However, network security is at the same level as password authentication.

### BRIEF DESCRIPTION OF DRAWINGS

FIG. 1 is a schematic view showing the arrangement of a VPN connection authentication system according to the embodiment;

FIG. 2 is a schematic view for explaining a processing process in this system;

FIG. 3 is a flowchart for explaining the operations of steps ST1 to ST15 in the embodiment;

FIG. 4 is a flowchart for explaining the operations of steps ST16 to ST33 in the embodiment; and

FIG. 5 is a schematic view for explaining an authentication information management DB 40 in the embodiment.

### DETAILED DESCRIPTION

In general, according to one embodiment, there is provided a VPN connection authentication system including a user terminal that is used by a user, an authentication server that is connected to the user terminal and configured to communicate with the user terminal, a biometric authentication result evidence information verification server that is incorporated in the authentication server or is connected to the authentication server and configured to communicate with the authentication server, an authentication information management DB configured to be writable from the authentication server, and a VPN connection server that is connected to the user terminal by VPN and configured to communicate with the user terminal.

The user terminal includes a communication unit configured to perform communication between the user terminal, and the authentication server and the VPN connection server.

The user terminal includes a display unit configured to display, for the user, a VPN connection request to the authentication server.

The user terminal includes an input unit configured to allow the user to decide the VPN connection request sent to the authentication server that is displayed by the display unit.

The user terminal includes a biometric authentication processing unit configured to receive a challenge value from the authentication server, execute biometric authentication of the user, generate biometric authentication result evidence information, and send back the biometric authentication result evidence information to the authentication server.

The user terminal includes a transmission content generation unit configured to, when authentication by the authentication server succeeds, generate, from an ID and token received from the authentication server, information in which the ID and the token have a format for requesting authentication to the VPN connection server.

The user terminal includes a control unit configured to control the display unit, the input unit, the biometric authentication processing unit, the transmission content generation unit, and the VPN connection unit to execute processes corresponding to a content of communication between the authentication server or a VPN connection server of the user terminal, and the user terminal, and transmit results of executing the processes to the authentication server or the VPN connection server, as needed.

The authentication server includes a communication unit configured to perform communication between the user terminal and the biometric authentication result evidence information verification server, and the authentication server.

The authentication server includes a challenge value generation unit configured to generate a challenge value to be transmitted to the user terminal in response to a VPN connection request from the user terminal.

The authentication server includes a token generation unit configured to generate the token when verification by the biometric authentication result evidence information verification server succeeds.

The authentication server includes a DB processing unit configured to write the token to the authentication information management DB.

The authentication server includes a control unit. The control unit controls the challenge value generation unit, the token generation unit, and the DB processing unit of the authentication server to execute processes corresponding to a content of communication between the user terminal or the biometric authentication result evidence information verification server, and the authentication server, and transmits results of executing the processes to the authentication server or the VPN connection server, as needed.

The biometric authentication result evidence information verification server includes a communication unit configured to perform communication between the authentication server and the biometric authentication result evidence information verification server.

The biometric authentication result evidence information verification server includes a biometric authentication result evidence information verification unit. The biometric authentication result evidence information verification unit verifies biometric authentication result evidence information that is generated by the biometric authentication processing unit of the user terminal and received through the authentication server, and when the verification succeeds, sends back a result of the verification and a user identifier included in the biometric authentication result evidence information to the authentication server.

The authentication information management DB stores, in correspondence with each user, a user identifier regarding biometric authentication processing, and the ID and token of a user who uses the VPN connection server.

The VPN connection server includes a communication unit configured to perform communication between the user terminal and the VPN connection server.

The VPN connection server includes a DB processing unit configured to read a pair of the ID and the token from the authentication information management DB.

The VPN connection server includes a token verification unit configured to verify whether the token of the ID and token received from the user terminal and the token read from the authentication information management DB by using the ID as a key match each other.

The VPN connection server includes a VPN connection unit configured to enable VPN communication between the user terminal and the VPN connection server.

The VPN connection server includes a control unit configured to, upon receiving the ID and the token from the user terminal, execute the DB processing unit of the VPN connection server, the token verification unit, and the VPN connection unit of the VPN connection server, and transmit results of executing the DB processing unit, the token verification unit, and the VPN connection unit to the user terminal, as needed.

Embodiments will now be described with reference to the accompanying drawings. Note that each of the following apparatuses can be implemented by either a hardware configuration or a combined configuration of a hardware resource and software. The software in the combined configuration is a program that is installed in advance in the computer of a corresponding apparatus from a network or a storage medium to implement the function of the corresponding apparatus.

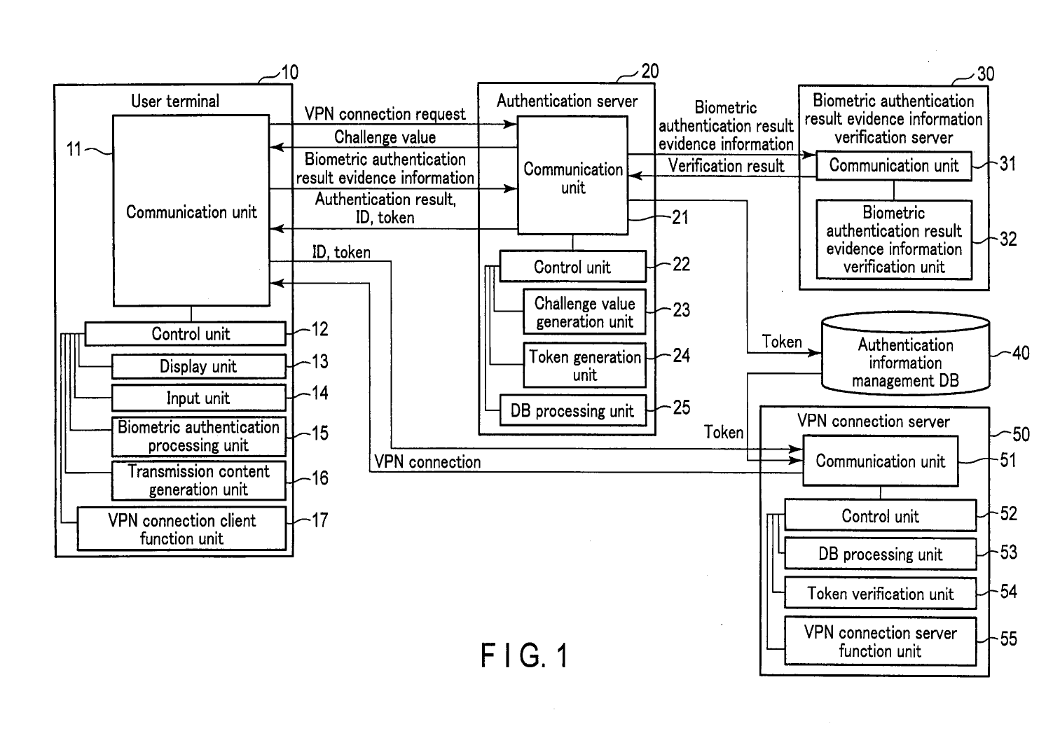

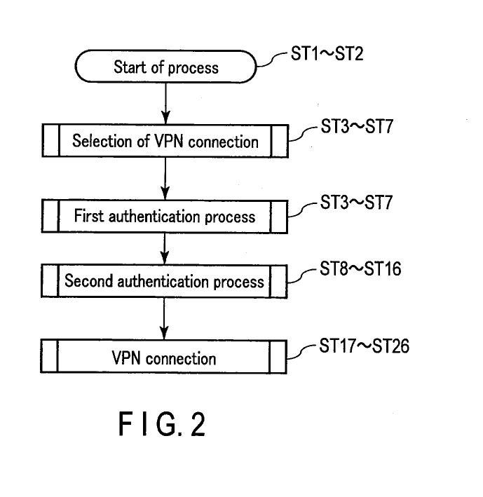

FIG. 1 is a schematic view showing the arrangement of a VPN connection authentication system according to the embodiment. FIG. 2 is a schematic view for explaining a processing process in this system. As shown in FIG. 2, the processing process is constituted by a VPN connection request, a first authentication process, a second authentication process, and a VPN connection.

Authentication processing is processing for confirming whether an authentication target (e.g., a person or apparatus) is authentic. “Authentic” indicates a case in which an authentication target satisfies a criterion to recognize by a verifier that the target is correct.

The following description assumes that a user has a user identifier regarding biometric authentication processing, and the ID of a user who uses a VPN connection server. The user identifier and the ID may be different or the same.

The VPN connection authentication system according to the embodiment includes a user terminal 10, an authentication server 20, a biometric authentication result evidence information verification server 30, an authentication information management DB (Data Base) 40, and a VPN connection server 50.

The user terminal 10 is a terminal that is used by a user. The user terminal 10 is connected to the authentication server 20 and the VPN connection server 50, and can communicate with them.

The authentication server 20 is connected to the user terminal 10 and the authentication information management DB 40. The authentication server 20 may incorporate the biometric authentication result evidence information verification server 30, or may be externally connected to the biometric authentication result evidence information verification server 30, as shown in FIG. 1, so that it can communicate with the biometric authentication result evidence information verification server 30.

The biometric authentication result evidence information verification server 30 may be incorporated in the authentication server 20, or may be externally connected to the authentication server 20, as shown in FIG. 1, so that it can communicate with the authentication server 20.

The authentication information management DB 40 is connected to the authentication server 20 and the VPN connection server 50 so that it can communicate with the authentication server 20 and the VPN connection server 50.

The VPN connection server 50 is connected to the user terminal 10 and the authentication information management DB 40 so that it can communicate with the user terminal 10 and the authentication information management DB 40.

The user terminal 10 has normal computer functions. The user terminal 10 includes, for example, a communication unit 11, a control unit 12, a display unit 13, an input unit 14, a biometric authentication processing unit 15, a transmission content generation unit 16, and a VPN connection client function unit 17. The communication unit 11, the control unit 12, the biometric authentication processing unit 15, the transmission content generation unit 16, and the VPN connection client function unit 17 are implemented by a processor, for example, a CPU. The user terminal 10 may be, for example, a mobile phone (feature phone), a smartphone, or a tablet terminal. The respective units of the user terminal 10 will be explained below.

The communication unit 11 is a communication interface between the user terminal 10, the authentication server 20, and the VPN connection server 50. In the following explanation, a description “through the communication unit 11 at the time of communication” applies to all cases and thus will be omitted.

The control unit 12 controls the display unit 13, the input unit 14, the biometric authentication processing unit 15, the transmission content generation unit 16, and the VPN connection client function unit 17 to execute one or a plurality of processes corresponding to the contents of communication with the authentication server 20 or the VPN connection server 50. If necessary, the control unit 12 transmits the results of these processes to the authentication server 20 or the VPN connection server 50. The control unit 12 has, for example, the following functions (f12-1) to (f12-4):

(f12-1) A VPN connection request transmission function of transmitting a VPN connection authentication request to the authentication server 20.

(f12-2) A biometric authentication result evidence information transmission function of, when an authentication request to request execution of biometric authentication as a request generated by the authentication server 20, and a random challenge value generated by the authentication server 20 are received from the authentication server 20, transmitting transmission contents generated by the transmission content generation unit 16 as biometric authentication result evidence information to the authentication server 20 based on biometric authentication result evidence information that is generated by the biometric authentication processing unit 15 in correspondence with the challenge value.

(f12-3) An ID/token transmission function of, when an authentication result, ID, and token from the authentication server 20 are received, transmitting, from the transmission content generation unit 16 to the VPN connection server 50, transmission contents that are generated by the transmission content generation unit 16 based on the ID and the token.

(f12-4) A VPN connection communication function of, when the VPN connection server 50 permits a VPN connection as a result of transmitting an ID and a token to the VPN connection server 50, transmitting the result of processing in the VPN connection client function unit 17 as a processing result of executing processing of transmission/reception contents for VPN communication with the VPN connection server 50.

The token is information used for biometric authentication that is executed in the above processing. The token includes a temporarily generated one-time password and the like.

The display unit 13 has a display function. This display function displays, for example, a VPN connection request to the authentication server 20, an authentication request from the authentication server 20, an operation instruction from the biometric authentication processing unit 15, an authentication result in the authentication server 20, and a status of VPN connection with the VPN connection server 50.

The input unit 14 has an input function of, for example, allowing a user to decide to send a VPN connection request to the authentication server 20 that is displayed on the display unit 13.

The biometric authentication processing unit 15, for example, a device used for biometric authentication, such as a fingerprint sensor or a CCD camera is usable, as needed. When a VPN connection request is sent to the authentication server 20 and the user terminal 10 receives a challenge value from the authentication server 20, the biometric authentication processing unit 15 receives, from the control unit 12 together with the challenge value, an execution request to request execution of biometric authentication in the user terminal 10, and executes biometric authentication processing. Then, the biometric authentication processing unit 15 generates biometric authentication result evidence information including the challenge value, and sends back the generation result to the control unit 12.

Based on the authentication result, ID, and token received from the authentication server 20, the transmission content generation unit 16 generates information containing the ID and the token in an authentication request format, which is then sent to the VPN connection server 50.

After authentication by the VPN connection server 50 succeeds, the VPN connection client function unit 17 executes a VPN connection between the user terminal 10 and the VPN connection server 50.

The authentication server 20 includes a communication unit 21, a control unit 22, a challenge value generation unit 23, a token generation unit 24, and a DB processing unit 25. The communication unit 21, the control unit 22, the challenge value generation unit 23, the token generation unit 24, and the DB processing unit 25 are implemented by the processor. The respective units of the authentication server 20 will be explained below.

The communication unit 21 is a communication interface with the authentication server 20, the user terminal 10, and the biometric authentication result evidence information verification server 30. In the following explanation, a description “through the communication unit 21 at the time of communication” applies to all cases and thus will be omitted.

The control unit 22 controls the challenge value generation unit 23, the token generation unit 24, and the DB processing unit 25 to execute processing corresponding to the contents of communication with the user terminal 10 or the biometric authentication result evidence information verification server 30. If necessary, the control unit 22 transmits these results to the user terminal 10 or the biometric authentication result evidence information verification server 30. The control unit 22 has, for example, the following functions (f22-1) to (f22-4):

(f22-1) A challenge value transmission function of controlling the challenge value generation unit 23 to generate a challenge value in response to a VPN connection request from the user terminal 10, and transmitting the generated challenge value to the user terminal 10.

(f22-2) A biometric authentication result evidence information verification request function of requesting the biometric authentication result evidence information verification server 30 to verify biometric authentication result evidence information transmitted from the user terminal 10.

(f22-3) A token write function of, when the biometric authentication result evidence information verification server 30 verifies that the contents of biometric authentication result evidence information are consistent and correct, and as a result, biometric authentication is correctly executed and succeeds, controlling the token generation unit 24 to generate a token for a verification result and user identifier transmitted from the biometric authentication result evidence information verification server 30, and controlling the DB processing unit 25 to write the token for the record of the user identifier to the authentication information management DB 40.

(f22-4) A verification result transmission function of, when the result of verification by (f22-2) is transmitted to the user terminal 10 after the end of (f22-2), the verification of biometric authentication result evidence information by (f22-2) succeeds, and (f22-3) also ends, transmitting, to the user terminal 10, an ID and token obtained by searching for an ID corresponding to the user identifier by the DB processing unit 25.

The challenge value generation unit 23 has a function of generating a challenge to be transmitted to the user terminal 10 in response to a processing request from the control unit 22 when the authentication server 20 receives a VPN connection request from the user terminal 10.

The token generation unit 24 has a function of generating a token in response to a processing request from the control unit 22 when a verification result from the biometric authentication result evidence information verification server 30 represents a success. This token is written to the authentication information management DB 40 and then transmitted to the user terminal 10.

The DB processing unit 25 has a function of writing a token generated by the token generation unit 24 to the authentication information management DB 40 in association with a user identifier sent back from the biometric authentication result evidence information verification server 30 together with a verification result.

The biometric authentication result evidence information verification server 30 includes a communication unit 31 and a biometric authentication result evidence information verification unit 32. The communication unit 31 and the biometric authentication result evidence information verification unit 32 are implemented by the processor.

The communication unit 31 is a communication interface with the authentication server 20. In the following explanation, a description “through the communication unit 31 at the time of communication” applies to all cases and thus will be omitted.

The biometric authentication result evidence information verification unit 32 verifies biometric authentication result evidence information generated by the biometric authentication processing unit 15 of the user terminal 10. The biometric authentication result evidence information verification unit 32 has a function of, when it is verified that the contents of biometric authentication result evidence information are consistent and correct, as a result, biometric authentication is correctly executed, and verification succeeds, extracting a user identifier included in the biometric authentication result evidence information as an identifier to be transmitted to the authentication server 20 together with the verification result.

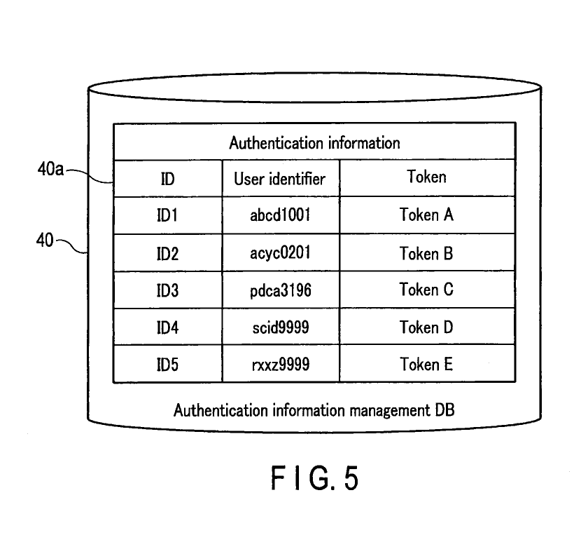

As shown in FIG. 5, the authentication information management DB 40 stores authentication information 40a. In correspondence with each user, the authentication information 40a stores a user identifier regarding biometric authentication processing, and the ID and token of a user who uses the VPN connection server. The authentication information management DB 40 has a function of writing a token to the authentication information management DB 40 by the authentication server 20 using each of a user identifier and ID as a key. Similarly, the authentication information management DB 40 has a function of reading a token by the VPN connection server 50. Note that the authentication information management DB 40 may be a DB management server having a communication function, or an LDAP (Lightweight Directory Access Protocol) server.

The VPN connection server 50 includes a communication unit 51, a control unit 52, a DB processing unit 53, a token verification unit 54, and a VPN connection server function unit 55. The communication unit 51, the control unit 52, the DB processing unit 53, the token verification unit 54, and the VPN connection server function unit 55 are implemented by the processor. The respective units of the VPN connection server 50 will be explained below.

The communication unit 51 is a communication interface for performing communication with the user terminal 10. In the following explanation, a description “through the communication unit 51 at the time of communication” applies to all cases and thus will be omitted.

Upon receiving an ID and a token from the user terminal 10, the control unit 52 executes the DB processing unit 53, the token verification unit 54, and the VPN connection server function unit 55, and transmits these results to the user terminal 10, as needed. The control unit 52 has, for example, the following functions (f52-1) to (f52-3):

(f52-1) A token read function of, upon receiving an ID and a token from the user terminal 10, controlling the DB processing unit 53 to execute read of a token in the authentication information management DB 40 by using the ID as a key.

(f52-2) A token verification function of controlling the token verification unit 54 to verify whether the token received from the user terminal 10 and the token read by (f52-1) match each other.

(f52-3) A VPN connection communication function of, when it is verified by (f52-2) that these tokens match each other, permitting a VPN connection between the user terminal 10 and the VPN connection server 50, and transmitting the result of processing by the VPN connection server function unit 55 that executes processing of transmission/reception contents for performing VPN communication between the user terminal 10 and the VPN connection server 50.

Execution of processing of transmission/reception contents is execution of processing such as encryption to be performed before or after (before the time of transmission or after the time of reception) exchange of communication data between the user terminal 10 and the VPN connection server 50. This is the function of the VPN connection server function unit 55 and is thus the function of the VPN connection client function unit 17. Note that communication itself is executed by the communication unit 51.

The DB processing unit 53 has a function of reading a token in the authentication information management DB 40 by using, as a key, an ID received from the user terminal 10.

The token verification unit 54 has a function of verifying whether a token received from the user terminal 10, and a token read from the authentication information management DB 40 by the DB processing unit 53 match each other.

The VPN connection server function unit 55 also has a function of, after authentication by the VPN connection server 50 succeeds, executing a VPN connection with the VPN connection client function unit 17 of the user terminal 10.

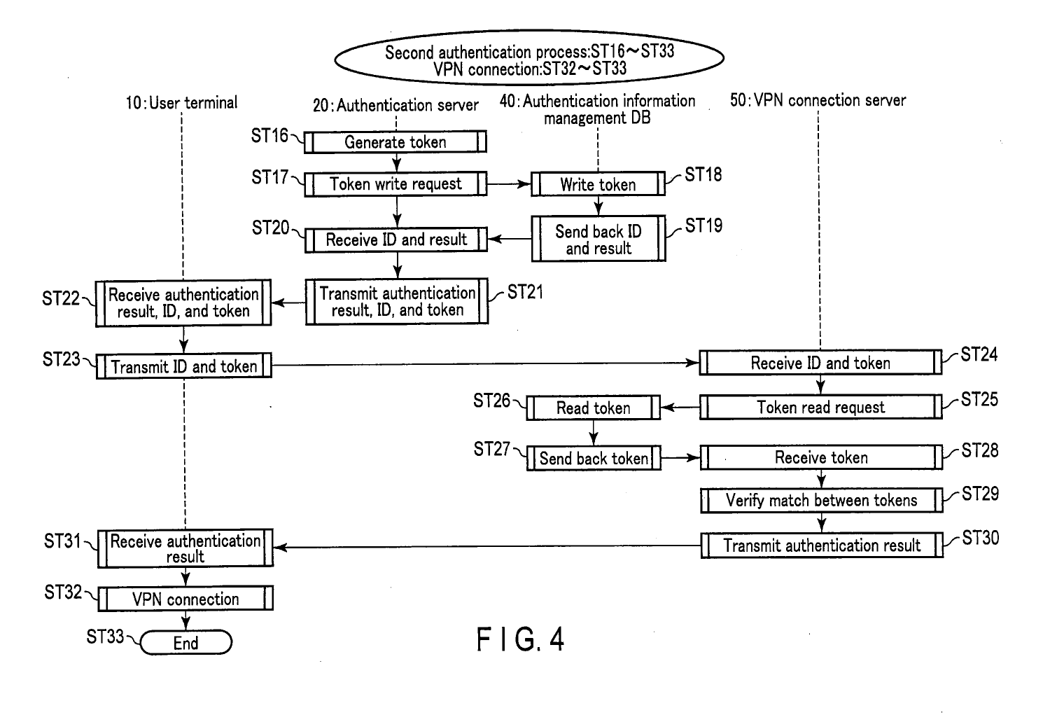

The operation of the VPN connection authentication system having the above-described arrangement will be explained with reference to the flowcharts of FIGS. 2, 3, and 4.

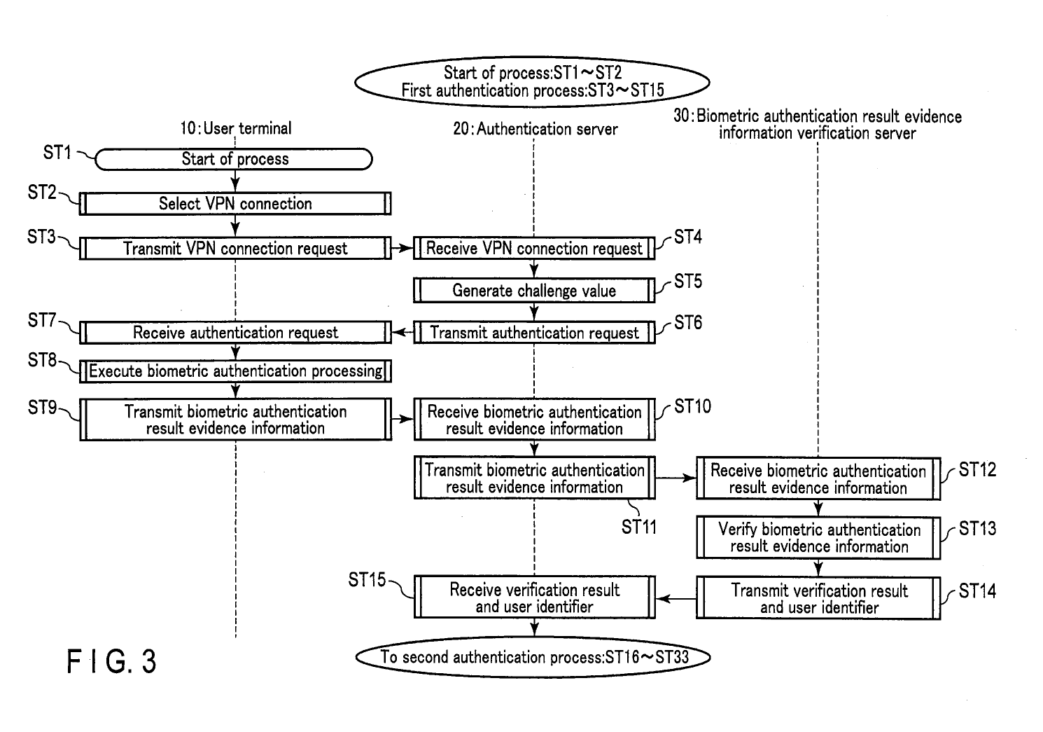

In the user terminal 10, as shown in FIG. 3, the user selects a VPN connection request from the input unit 14 in accordance with a window displayed on the display unit 13 (ST2). Then, the user terminal 10 transmits the VPN connection request to the authentication server 20 (ST3). In response to this, the first authentication process starts.

In the authentication server 20, the communication unit 21 receives the VPN connection request (ST4), and the control unit 22 executes subsequent authentication processing in accordance with an authentication method determined in advance or designated by the VPN connection request.

The control unit 22 controls the challenge value generation unit 23 to generate a challenge value formed from a random number or the like (ST5), holds the challenge value, and transmits the challenge value and an authentication request to the user terminal 10 (ST6). The authentication request may include, for example, information that designates authentication processing, and information that designates several matching algorithms.

The user terminal 10 receives the challenge value and the authentication request (ST7), and the control unit 12 transfers the challenge value and a biometric authentication processing execution request to the biometric authentication processing unit 15 (ST8).

Upon receiving the challenge value and the biometric authentication processing execution request, the biometric authentication processing unit 15 executes biometric authentication processing, generates biometric authentication result evidence information including the challenge value (ST8), and transmits it to the authentication server 20 (ST9). The “biometric authentication result evidence information” is information of a biometric authentication product used in biometric authentication, the certificate of biometric information that has been registered in advance and used, or the like.

The authentication server 20 receives the biometric authentication result evidence information from the user terminal 10 (ST10), and transmits it to the biometric authentication result evidence information verification server 30 (ST11).

The biometric authentication result evidence information verification server 30 receives the biometric authentication result evidence information from the authentication server 20 (ST12), and controls the biometric authentication result evidence information verification unit 32 to verify the biometric authentication result evidence information.

The biometric authentication result evidence information verification unit 32 verifies the biometric authentication result evidence information, and extracts a user identifier included in the biometric authentication result evidence information (ST13).

The biometric authentication result evidence information verification server 30 transmits the verification result of the biometric authentication result evidence information to the authentication server 20. If the verification by the biometric authentication result evidence information verification unit 32 succeeds, the biometric authentication result evidence information verification server 30 transmits even the user identifier to the authentication server 20 together with the verification result (ST14).

The authentication server 20 receives the result of verification by the biometric authentication result evidence information verification unit 32 from the biometric authentication result evidence information verification server 30 (ST15). If this verification succeeds, the token generation unit 24 generates a token (ST16). In response to this, the second authentication process starts.

The DB processing unit 25 writes the token to the authentication information management DB 40 for the user identifier sent back from the biometric authentication result evidence information verification server 30 to the authentication server 20 together with the verification result. At the same time as the write, the DB processing unit 25 inquires of an ID corresponding to the token, of the authentication information management DB 40 (ST17).

The authentication information management DB 40 writes the token corresponding to the user identifier designated from the authentication server 20 through the DB processing unit 25 (ST18). The authentication information management DB 40 searches for an ID corresponding to the user identifier, and sends back the found ID to the authentication server 20 together with the token write result (ST19).

The authentication server 20 receives the token write result and ID that have been sent back from the authentication information management DB 40 (ST20). The authentication server 20 transmits the ID and the token generated in ST16 to the user terminal 10 (ST21).

The user terminal 10 receives the ID and the token from the authentication server 20 (ST22). The transmission content generation unit 16 generates, based on the ID and the token, contents to be transmitted to the VPN connection server 50, and transmits the generation result to the VPN connection server 50 through the communication unit 21 (ST23).

The VPN connection server 50 receives the ID and the token from the user terminal 10 (ST24). Then, the DB processing unit 53 requests the authentication information management DB 40 to read a token corresponding to an ID stored in the authentication information management DB 40 (ST25).

The authentication information management DB 40 reads a token corresponding to the designated ID in response to the read request from the VPN connection server 50 (ST26), and sends back the read token to the VPN connection server 50 (ST27).

The VPN connection server 50 receives the token from the authentication information management DB 40 (ST28). Then, the token verification unit 54 verifies whether this token matches the token received in ST24 from the user terminal 10 (ST29). If these tokens match each other, the VPN connection server 50 transmits a signal representing an authentication success to the user terminal 10. If these tokens do not match each other, the VPN connection server 50 transmits a signal representing an authentication failure to the user terminal 10 (ST30).

The user terminal 10 receives the authentication result from the VPN connection server 50 (ST31). If the received authentication result represents a success, the VPN connection client function unit 17 establishes a VPN connection with the VPN connection server function unit 55 of the VPN connection server 50 (ST32), and ends the VPN connection authentication processing (ST33).

Note that the method described in each of the aforementioned embodiments can be stored in a storage medium such as a magnetic disk (a Floppy® disk, a hard disk, or the like), an optical disk (a CD-ROM, a DVD, or the like), a magnetooptical disk (MO), or a semiconductor memory as a program executable by a computer, and can be distributed.

Any storage format may be adopted as long as the storage medium can store a program, and is readable by the computer.

An OS (Operating System) operating on the computer, MW (middleware) such as database management software or network software, or the like may execute part of each process for implementing the aforementioned embodiments based on the instruction of the program installed from the storage medium to the computer.

The storage medium according to each of the embodiments is not limited to a medium independent of the computer, and also includes a storage medium that stores or temporarily stores the program transmitted by a LAN, the Internet, or the like by downloading it.

The number of storage media is not limited to one. The storage medium according to the present invention also incorporates a case in which the processing of each of the aforementioned embodiments is executed from a plurality of media, and the media can have any arrangement. Note that the computer according to each of the embodiments is configured to execute each process of each of the aforementioned embodiments based on the program stored in the storage medium, and may be, for example, a single device formed from a personal computer or a system including a plurality of devices connected via a network.

The computer according to each of the embodiments is not limited to a personal computer, and also includes an arithmetic processing device or microcomputer included in an information processing apparatus. The term “computer” collectively indicates apparatuses and devices capable of implementing the functions of the present invention by the program.

While a certain embodiment has been described, this embodiment has been presented by way of example only, and is not intended to limit the scope of the inventions. Indeed, the novel embodiment described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A VPN connection authentication system comprising a user terminal that is used by a user, an authentication server that is connected to the user terminal and configured to communicate with the user terminal, a biometric authentication result evidence information verification server that is incorporated in the authentication server or is connected to the authentication server and configured to communicate with the authentication server, an authentication information management DB configured to be writable from the authentication server, and a VPN (Virtual Private Network) connection server that is connected to the user terminal by VPN and configured to communicate with the user terminal,
wherein the user terminal includes:
a communication unit configured to perform communication between the user terminal, and the authentication server and the VPN connection server;
a display unit configured to display a VPN connection request to the authentication server;
an input unit configured to accept an input for deciding the VPN connection request displayed by the display unit;
a biometric authentication processing unit configured to receive a challenge value from the authentication server, execute biometric authentication of the user in correspondence with the challenge value, generate biometric authentication result evidence information, and send back the biometric authentication result evidence information to the authentication server;
a transmission content generation unit configured to, when authentication by the authentication server succeeds, generate, based on an ID and token received from the authentication server, information in which the ID and the token have a format for requesting authentication to the VPN connection server; and
a control unit configured to control the display unit, the input unit, the biometric authentication processing unit, the transmission content generation unit, and a VPN connection unit of the user terminal to execute processes corresponding to a content of communication between the authentication server or the VPN connection server, and the user terminal, and transmit results of executing the processes to the authentication server or the VPN connection server, as needed,
the authentication server includes:
a communication unit configured to perform communication between the authentication server, and the user terminal and the biometric authentication result evidence information verification server;
a challenge value generation unit configured to generate a challenge value to be transmitted to the user terminal in response to a VPN connection request from the user terminal;
a token generation unit configured to generate the token when verification by the biometric authentication result evidence information verification server succeeds;
a DB processing unit configured to write the token to the authentication information management DB; and
a control unit configured to control the challenge value generation unit, the token generation unit, and the DB processing unit of the authentication server to execute processes corresponding to a content of communication between the user terminal or the biometric authentication result evidence information verification server, and the authentication server, and transmit results of executing the processes to the authentication server or the VPN connection server, as needed,
the biometric authentication result evidence information verification server includes:
a communication unit configured to perform communication between the biometric authentication result evidence information verification server and the authentication server; and
a biometric authentication result evidence information verification unit configured to verify biometric authentication result evidence information that is generated by the biometric authentication processing unit of the user terminal and received through the authentication server, and when the verification succeeds, send back a result of the verification and a user identifier included in the biometric authentication result evidence information to the authentication server,
the authentication information management DB stores, in correspondence with each user, a user identifier regarding biometric authentication processing, and an ID and token of a user who uses the VPN connection server, and
the VPN connection server includes:
a communication unit configured to perform communication between the VPN connection server and the user terminal;
a DB processing unit configured to read a pair of the ID and the token from the authentication information management DB;
a token verification unit configured to verify whether a token received from the user terminal and the token read from the authentication information management DB by using the ID as a key match each other;
a VPN connection unit configured to enable VPN communication between the user terminal and the VPN connection server; and
a control unit configured to, upon receiving the ID and the token from the user terminal, execute the DB processing unit, the token verification unit, and the VPN connection unit of the VPN connection server, and transmit results of executing the DB processing unit, the token verification unit, and the VPN connection unit of the VPN connection server to the user terminal, as needed.

2. A user terminal used in a VPN connection authentication system including the user terminal that is used by a user, an authentication server that is connected to the user terminal and configured to communicate with the user terminal, a biometric authentication result evidence information verification server that is incorporated in the authentication server or is connected to the authentication server and configured to communicate with the authentication server, an authentication information management DB configured to be writable from the authentication server, and a VPN (Virtual Private Network) connection server that is connected to the user terminal by VPN and configured to communicate with the user terminal,
the authentication server including:
a challenge value generation unit configured to generate a challenge value to be transmitted to the user terminal in response to a VPN connection request from the user terminal;
a token generation unit configured to generate the token when verification by the biometric authentication result evidence information verification server succeeds;
a DB processing unit configured to write the token to the authentication information management DB; and
a control unit configured to control the challenge value generation unit, the token generation unit, and the DB processing unit of the authentication server to execute processes corresponding to a content of communication between the user terminal or the biometric authentication result evidence information verification server, and the authentication server, and transmit results of executing the processes to the VPN connection server, as needed,
the biometric authentication result evidence information verification server including:
a communication unit configured to perform communication between the biometric authentication result evidence information verification server and the authentication server; and
a biometric authentication result evidence information verification unit configured to verify biometric authentication result evidence information that is generated by the user terminal and received through the authentication server, and when the verification succeeds, send back a result of the verification and a user identifier included in the biometric authentication result evidence information to the authentication server,
the authentication information management DB storing, in correspondence with each user, a user identifier regarding biometric authentication processing, and an ID and token of a user who uses the VPN connection server, and
the VPN connection server including:
a communication unit configured to perform communication between the VPN connection server and the user terminal;
a DB processing unit configured to read a pair of the ID and the token from the authentication information management DB;
a token verification unit configured to verify whether a token received from the user terminal and the token read from the authentication information management DB by using the ID as a key match each other;
a VPN connection unit configured to enable VPN communication between the user terminal and the VPN connection server; and
a control unit configured to, upon receiving the ID and the token from the user terminal, execute the DB processing unit, the token verification unit, and the VPN connection unit of the VPN connection server, and transmit results of executing the DB processing unit, the token verification unit, and the VPN connection unit of the VPN connection server to the user terminal, as needed,
the user terminal comprising:
a communication unit configured to perform communication between the user terminal, and the authentication server and the VPN connection server;
a display unit configured to display a VPN connection request to the authentication server;
an input unit configured to accept an input for deciding the VPN connection request displayed by the display unit;
a biometric authentication processing unit configured to receive a challenge value from the authentication server, execute biometric authentication of the user in correspondence with the challenge value, generate biometric authentication result evidence information, and send back the biometric authentication result evidence information to the authentication server;
a transmission content generation unit configured to, when authentication by the authentication server succeeds, generate, based on an ID and token received from the authentication server, information in which the ID and the token have a format for requesting authentication to the VPN connection server; and
a control unit configured to control the display unit, the input unit, the biometric authentication processing unit, the transmission content generation unit, and a VPN connection unit of the user terminal to execute processes corresponding to a content of communication between the authentication server or the VPN connection server, and the user terminal, and transmit results of executing the processes to the authentication server or the VPN connection server, as needed.

3. An authentication server used in a VPN connection authentication system including a user terminal that is used by a user, the authentication server that is connected to the user terminal and configured to communicate with the user terminal, a biometric authentication result evidence information verification server that is incorporated in the authentication server or is connected to the authentication server and configured to communicate with the authentication server, an authentication information management DB configured to be writable from the authentication server, and a VPN (Virtual Private Network) connection server that is connected to the user terminal by VPN and configured to communicate with the user terminal,
the user terminal including:
a communication unit configured to perform communication between the user terminal, and the authentication server and the VPN connection server;
a display unit configured to display a VPN connection request to the authentication server;
an input unit configured to accept an input for deciding the VPN connection request displayed by the display unit;
a biometric authentication processing unit configured to receive a challenge value from the authentication server, execute biometric authentication of the user in correspondence with the challenge value, generate biometric authentication result evidence information, and send back the biometric authentication result evidence information to the authentication server;
a transmission content generation unit configured to, when authentication by the authentication server succeeds, generate, based on an ID and token received from the authentication server, information in which the ID and the token have a format for requesting authentication to the VPN connection server; and
a control unit configured to control the display unit, the input unit, the biometric authentication processing unit, the transmission content generation unit, and a VPN connection unit of the user terminal to execute processes corresponding to a content of communication between the authentication server or the VPN connection server, and the user terminal, and transmit results of executing the processes to the authentication server or the VPN connection server, as needed,
the biometric authentication result evidence information verification server including:
a communication unit configured to perform communication between the biometric authentication result evidence information verification server and the authentication server; and
a biometric authentication result evidence information verification unit configured to verify biometric authentication result evidence information that is generated by the biometric authentication processing unit of the user terminal and received through the authentication server, and when the verification succeeds, send back a result of the verification and a user identifier included in the biometric authentication result evidence information to the authentication server,
the authentication information management DB storing, in correspondence with each user, a user identifier regarding biometric authentication processing, and an ID and token of a user who uses the VPN connection server, and
the VPN connection server including:
a communication unit configured to perform communication between the VPN connection server and the user terminal;
a DB processing unit configured to read a pair of the ID and the token from the authentication information management DB;
a token verification unit configured to verify whether a token received from the user terminal and the token read from the authentication information management DB by using the ID as a key match each other;
a VPN connection unit configured to enable VPN communication between the user terminal and the VPN connection server; and
a control unit configured to, upon receiving the ID and the token from the user terminal, execute the DB processing unit, the token verification unit, and the VPN connection unit of the VPN connection server, and transmit results of executing the DB processing unit, the token verification unit, and the VPN connection unit of the VPN connection server to the user terminal, as needed,
the authentication server comprising:
a communication unit configured to perform communication between the authentication server, and the user terminal and the biometric authentication result evidence information verification server;
a challenge value generation unit configured to generate a challenge value to be transmitted to the user terminal in response to a VPN connection request from the user terminal;
a token generation unit configured to generate the token when verification by the biometric authentication result evidence information verification server succeeds;
a DB processing unit configured to write the token to the authentication information management DB; and
a control unit configured to control the challenge value generation unit, the token generation unit, and the DB processing unit of the authentication server to execute processes corresponding to a content of communication between the user terminal or the biometric authentication result evidence information verification server, and the authentication server, and transmit results of executing the processes to the VPN connection server, as needed.

4. A biometric authentication result evidence information verification server used in a VPN connection authentication system including a user terminal that is used by a user, an authentication server that is connected to the user terminal and configured to communicate with the user terminal, the biometric authentication result evidence information verification server that is incorporated in the authentication server or is connected to the authentication server and configured to communicate with the authentication server, an authentication information management DB configured to be writable from the authentication server, and a VPN (Virtual Private Network) connection server that is connected to the user terminal by VPN and configured to communicate with the user terminal,
the user terminal including:
a communication unit configured to perform communication between the user terminal, and the authentication server and the VPN connection server;
a display unit configured to display a VPN connection request to the authentication server;
an input unit configured to accept an input for deciding the VPN connection request displayed by the display unit;
a biometric authentication processing unit configured to receive a challenge value from the authentication server, execute biometric authentication of the user in correspondence with the challenge value, generate biometric authentication result evidence information, and send back the biometric authentication result evidence information to the authentication server;
a transmission content generation unit configured to, when authentication by the authentication server succeeds, generate, based on an ID and token received from the authentication server, information in which the ID and the token have a format for requesting authentication to the VPN connection server; and
a control unit configured to control the display unit, the input unit, the biometric authentication processing unit, the transmission content generation unit, and a VPN connection unit of the user terminal to execute processes corresponding to a content of communication between the authentication server or the VPN connection server, and the user terminal, and transmit results of executing the processes to the authentication server or the VPN connection server, as needed,
the authentication server including:
a communication unit configured to perform communication between the authentication server, and the user terminal and the biometric authentication result evidence information verification server;
a challenge value generation unit configured to generate a challenge value to be transmitted to the user terminal in response to a VPN connection request from the user terminal;
a token generation unit configured to generate the token when verification by the biometric authentication result evidence information verification server succeeds;
a DB processing unit configured to write the token to the authentication information management DB; and
a control unit configured to control the challenge value generation unit, the token generation unit, and the DB processing unit of the authentication server to execute processes corresponding to a content of communication between the user terminal or the biometric authentication result evidence information verification server, and the authentication server, and transmit results of executing the processes to the authentication server or the VPN connection server, as needed,
the authentication information management DB storing, in correspondence with each user, a user identifier regarding biometric authentication processing, and an ID and token of a user who uses the VPN connection server, and
the VPN connection server including:
a communication unit configured to perform communication between the VPN connection server and the user terminal;
a DB processing unit configured to read a pair of the ID and the token from the authentication information management DB;
a token verification unit configured to verify whether a token received from the user terminal and the token read from the authentication information management DB by using the ID as a key match each other;
a VPN connection unit configured to enable VPN communication between the user terminal and the VPN connection server; and
a control unit configured to, upon receiving the ID and the token from the user terminal, execute the DB processing unit, the token verification unit, and the VPN connection unit of the VPN connection server, and transmit results of executing the DB processing unit, the token verification unit, and the VPN connection unit of the VPN connection server to the user terminal, as needed,
the biometric authentication result evidence information verification server comprising:
a communication unit configured to perform communication between the biometric authentication result evidence information verification server and the authentication server; and
a biometric authentication result evidence information verification unit configured to verify biometric authentication result evidence information that is generated by the biometric authentication processing unit of the user terminal and received through the authentication server, and when the verification succeeds, send back a result of the verification and a user identifier included in the biometric authentication result evidence information to the authentication server.

5. A VPN connection server used in a VPN connection authentication system including a user terminal that is used by a user, an authentication server that is connected to the user terminal and configured to communicate with the user terminal, a biometric authentication result evidence information verification server that is incorporated in the authentication server or is connected to the authentication server and configured to communicate with the authentication server, an authentication information management DB configured to be writable from the authentication server, and the VPN (Virtual Private Network) connection server that is connected to the user terminal by VPN and configured to communicate with the user terminal,
the user terminal including:
a communication unit configured to perform communication between the user terminal, and the authentication server and the VPN connection server;
a display unit configured to display a VPN connection request to the authentication server;
an input unit configured to accept an input for deciding the VPN connection request displayed by the display unit;
a biometric authentication processing unit configured to receive a challenge value from the authentication server, execute biometric authentication of the user in correspondence with the challenge value, generate biometric authentication result evidence information, and send back the biometric authentication result evidence information to the authentication server;
a transmission content generation unit configured to, when authentication by the authentication server succeeds, generate, based on an ID and token received from the authentication server, information in which the ID and the token have a format for requesting authentication to the VPN connection server; and
a control unit configured to control the display unit, the input unit, the biometric authentication processing unit, the transmission content generation unit, and a VPN connection unit of the user terminal to execute processes corresponding to a content of communication between the authentication server or the VPN connection server, and the user terminal, and transmit results of executing the processes to the authentication server or the VPN connection server, as needed,
the authentication server including:
a communication unit configured to perform communication between the authentication server, and the user terminal and the biometric authentication result evidence information verification server;
a challenge value generation unit configured to generate a challenge value to be transmitted to the user terminal in response to a VPN connection request from the user terminal;
a token generation unit configured to generate the token when verification by the biometric authentication result evidence information verification server succeeds;
a DB processing unit configured to write the token to the authentication information management DB; and
a control unit configured to control the challenge value generation unit, the token generation unit, and the DB processing unit of the authentication server to execute processes corresponding to a content of communication between the user terminal or the biometric authentication result evidence information verification server, and the authentication server, and transmit results of executing the processes to the authentication server or the VPN connection server, as needed,
the biometric authentication result evidence information verification server including:
a communication unit configured to perform communication between the biometric authentication result evidence information verification server and the authentication server; and
a biometric authentication result evidence information verification unit configured to verify biometric authentication result evidence information that is generated by the biometric authentication processing unit of the user terminal and received through the authentication server, and when the verification succeeds, send back a result of the verification and a user identifier included in the biometric authentication result evidence information to the authentication server, and
the authentication information management DB storing, in correspondence with each user, a user identifier regarding biometric authentication processing, and an ID and token of a user who uses the VPN connection server,
the VPN connection server comprising:
a communication unit configured to perform communication between the VPN connection server and the user terminal;
a DB processing unit configured to read a pair of the ID and the token from the authentication information management DB;
a token verification unit configured to verify whether a token received from the user terminal and the token read from the authentication information management DB by using the ID as a key match each other;
a VPN connection unit configured to enable VPN communication between the user terminal and the VPN connection server; and
a control unit configured to, upon receiving the ID and the token from the user terminal, execute the DB processing unit, the token verification unit, and the VPN connection unit of the VPN connection server, and transmit results of executing the DB processing unit, the token verification unit, and the VPN connection unit of the VPN connection server to the user terminal, as needed.

6. A computer program product for causing a computer serving as a user terminal used in a VPN connection authentication system including the user terminal that is used by a user, an authentication server that is connected to the user terminal and configured to communicate with the user terminal, a biometric authentication result evidence information verification server that is incorporated in the authentication server or is connected to the authentication server and configured to communicate with the authentication server, an authentication information management DB configured to be writable from the authentication server, and a VPN (Virtual Private Network) connection server that is connected to the user terminal by VPN and configured to communicate with the user terminal,
the authentication server including:
a challenge value generation unit configured to generate a challenge value to be transmitted to the user terminal in response to a VPN connection request from the user terminal;
a token generation unit configured to generate the token when verification by the biometric authentication result evidence information verification server succeeds;
a DB processing unit configured to write the token to the authentication information management DB; and
a control unit configured to control the challenge value generation unit, the token generation unit, and the DB processing unit of the authentication server to execute processes corresponding to a content of communication between the user terminal or the biometric authentication result evidence information verification server, and the authentication server, and transmit results of executing the processes to the VPN connection server, as needed,
the biometric authentication result evidence information verification server including:
a communication unit configured to perform communication between the biometric authentication result evidence information verification server and the authentication server; and
a biometric authentication result evidence information verification unit configured to verify biometric authentication result evidence information that is generated by the user terminal and received through the authentication server, and when the verification succeeds, send back a result of the verification and a user identifier included in the biometric authentication result evidence information to the authentication server,
the authentication information management DB storing, in correspondence with each user, a user identifier regarding biometric authentication processing, and an ID and token of a user who uses the VPN connection server, and
the VPN connection server including:
a communication unit configured to perform communication between the VPN connection server and the user terminal;
a DB processing unit configured to read a pair of the ID and the token from the authentication information management DB;
a token verification unit configured to verify whether a token received from the user terminal and the token read from the authentication information management DB by using the ID as a key match each other;
a VPN connection unit configured to enable VPN communication between the user terminal and the VPN connection server; and
a control unit configured to, upon receiving the ID and the token from the user terminal, execute the DB processing unit, the token verification unit, and the VPN connection unit of the VPN connection server, and transmit results of executing the DB processing unit, the token verification unit, and the VPN connection unit of the VPN connection server to the user terminal, as needed,
to function as:
a communication unit configured to perform communication between the user terminal, and the authentication server and the VPN connection server;
a display unit configured to display a VPN connection request to the authentication server;
an input unit configured to accept an input for deciding the VPN connection request displayed by the display unit;
a biometric authentication processing unit configured to receive a challenge value from the authentication server, execute biometric authentication of the user in correspondence with the challenge value, generate biometric authentication result evidence information, and send back the biometric authentication result evidence information to the authentication server;
a transmission content generation unit configured to, when authentication by the authentication server succeeds, generate, based on an ID and token received from the authentication server, information in which the ID and the token have a format for requesting authentication to the VPN connection server; and
a control unit configured to control the display unit, the input unit, the biometric authentication processing unit, the transmission content generation unit, and a VPN connection unit of the user terminal to execute processes corresponding to a content of communication between the authentication server or the VPN connection server, and the user terminal, and transmit results of executing the processes to the authentication server or the VPN connection server, as needed.

7. A computer program product for causing a computer serving as a biometric authentication result evidence information verification server used in a VPN connection authentication system including a user terminal that is used by a user, an authentication server that is connected to the user terminal and configured to communicate with the user terminal, the biometric authentication result evidence information verification server that is incorporated in the authentication server or is connected to the authentication server and configured to communicate with the authentication server, an authentication information management DB configured to be writable from the authentication server, and a VPN (Virtual Private Network) connection server that is connected to the user terminal by VPN and configured to communicate with the user terminal,
the user terminal including:
a communication unit configured to perform communication between the user terminal, and the authentication server and the VPN connection server;
a display unit configured to display a VPN connection request to the authentication server;
an input unit configured to accept an input for deciding the VPN connection request displayed by the display unit;
a biometric authentication processing unit configured to receive a challenge value from the authentication server, execute biometric authentication of the user in correspondence with the challenge value, generate biometric authentication result evidence information, and send back the biometric authentication result evidence information to the authentication server;
a transmission content generation unit configured to, when authentication by the authentication server succeeds, generate, based on an ID and token received from the authentication server, information in which the ID and the token have a format for requesting authentication to the VPN connection server; and
a control unit configured to control the display unit, the input unit, the biometric authentication processing unit, the transmission content generation unit, and a VPN connection unit of the user terminal to execute processes corresponding to a content of communication between the authentication server or the VPN connection server, and the user terminal, and transmit results of executing the processes to the authentication server or the VPN connection server, as needed,
the authentication server including:
a communication unit configured to perform communication between the authentication server, and the user terminal and the biometric authentication result evidence information verification server;
a challenge value generation unit configured to generate a challenge value to be transmitted to the user terminal in response to a VPN connection request from the user terminal;
a token generation unit configured to generate the token when verification by the biometric authentication result evidence information verification server succeeds;
a DB processing unit configured to write the token to the authentication information management DB; and
a control unit configured to control the challenge value generation unit, the token generation unit, and the DB processing unit of the authentication server to execute processes corresponding to a content of communication between the user terminal or the biometric authentication result evidence information verification server, and the authentication server, and transmit results of executing the processes to the authentication server or the VPN connection server, as needed,
the authentication information management DB storing, in correspondence with each user, a user identifier regarding biometric authentication processing, and an ID and token of a user who uses the VPN connection server, and
the VPN connection server including:
a communication unit configured to perform communication between the VPN connection server and the user terminal;
a DB processing unit configured to read a pair of the ID and the token from the authentication information management DB;
a token verification unit configured to verify whether a token received from the user terminal and the token read from the authentication information management DB by using the ID as a key match each other;
a VPN connection unit configured to enable VPN communication between the user terminal and the VPN connection server; and
a control unit configured to, upon receiving the ID and the token from the user terminal, execute the DB processing unit, the token verification unit, and the VPN connection unit of the VPN connection server, and transmit results of executing the DB processing unit, the token verification unit, and the VPN connection unit of the VPN connection server to the user terminal, as needed,
to function as:
a communication unit configured to perform communication between the biometric authentication result evidence information verification server and the authentication server; and
a biometric authentication result evidence information verification unit configured to verify biometric authentication result evidence information that is generated by the biometric authentication processing unit of the user terminal and received through the authentication server, and when the verification succeeds, send back a result of the verification and a user identifier included in the biometric authentication result evidence information to the authentication server.
